(19) United States
(12) Patent Application Publication
(10) Pub. No.: US 2003/0160098 A1
(43) Pub. Date: Aug. 28, 2003

(54) Electronic label and article archiving aid system using same

(76) Inventors: Philippe Gerard Lucien Humbert, Ornans (FR); Tijani Gharbi, Besancon (FR); Antoine Marie Dominique Foucaut, Saint Gorgon (FR); Pierre Gossioux, Issy-Les-Moulineaux (FR)

Correspondence Address: MARSHALL, GERSTEIN & BORUN, 6300 SEARS TOWER, 233 SOUTH WACKER, CHICAGO, IL, 60606-6357, US

(21) Appl. No.: 10/312,602

(22) PCT Filed: Jun. 18, 2001
(86) PCT No.: PCT/FR01/01896

(30) Foreign Application Priority Data
Jun. 23, 2000 (FR) 00/08075

(51) Int. Cl. G06F 17/60

(52) U.S. Cl. 235/385

(57) ABSTRACT

The invention concerns an electronic label (2) designed to be affixed on an article, the label comprising a central unit (5) including storage means (8) wherein are stored an identification code of the label and temporal data related to the article storage and also a time clock (7) and comparison means (9) for comparing the recorded temporal data with the time information supplied by the clock, the label further comprising communication means (4, 15). The central unit (5) is adapted to activate the communication means (4, 15) to transmit a warning message to an external device (1) when the time information supplied by the clock are in predetermined relationship with the recorded temporal data.

The present invention pertains to electronic labels and to a system for aiding the archiving of a plurality of articles using such labels.

More particularly, the invention relates to electronic labels which are intended to be affixed to articles required to be monitored, used and/or located at precise instants throughout the duration of their storage.

These articles may in particular consist of pharmaceutical products or of products offered for sale which are stored, sometimes in very large numbers, in shelves or repositories and which must be removed therefrom when for example their date of expiry or their use-by date falls due.

International patent application WO 98/58238 discloses electronic labels for articles of this type, which comprise in particular an audible or visible indicator and an electronic circuit which is programmed as a function of the date on which each article is for example to be monitored or checked by a user. When the date of expiry falls due, the electronic circuit then triggers the audible or visible indicator so as to allow the user to locate the label and consequently the article associated with said label.

However, when several labels trigger simultaneously, it is often very difficult to accurately locate the labels which have triggered from the set of electronic labels present, without having recourse to the user who must then check the labels one by one so as to accurately locate those which have triggered.

Likewise, this type of electronic label requires almost constant presence of the user in the shelves so that he can hear or see the electronic labels which may have triggered.

Moreover, since the indications on the labels are achieved solely with the help of visible or audible indicators, it is understood that the user must be situated in the immediate vicinity of the labels, otherwise he cannot be alerted to the fact that at least one label has triggered, this implying that the user must periodically carry out a complete inspection of the repositories or shelves.

The aim of the present invention is to remedy the problems cited above.

To this end, the subject of the invention is an electronic label intended to be affixed to an article, the label comprising a central unit which comprises storage means, characterized in that it furthermore comprises means of remote communication for at least transmitting warning messages to an external device, said means of communication being linked to the central unit, in that the storage means comprise an identifying code for the label and temporal data corresponding to a precise instant in relation to the storage of said article, in that the central unit also comprises a clock and means of comparison for comparing the temporal data recorded in the storage means with temporal information supplied by the clock, and in that the central unit is able to activate the means of communication so as to transmit a warning message to the external device when the temporal information supplied by the clock is in a predetermined relation with the recorded temporal data, the warning message comprising at least the identifying code by virtue of which the label can be identified.

By virtue of these provisions, the electronic label can trigger automatically at a precise instant, thus ensuring a wakeup function in relation to the stored article and also transmitting a coded message to the external device, this coded message allowing the external device to identify the label, and to inform the user that the article in question must be checked, used and/or removed from the repository.

Thus, the identification of the label is effected directly by reading an identifying code recorded in the storage means of the label, thereby making it possible to avoid the user having to undertake manual checks of the labels situated in proximity to the one which triggers. Moreover, all the labels which trigger are automatically identified by the external device, thereby making it possible for the user to rapidly consult the state of the stored articles, without having to periodically visit the shelves or other places of storage and thus avoiding any almost constant presence in the shelves.

In preferred embodiments of the invention, recourse may possibly furthermore be had to one and/or other of the following provisions:

the storage means also comprise supplementary data relating to the article to which the label is intended to be affixed, and these supplementary data are also sent to the external device by the warning message when the temporal information supplied by the clock is in a predetermined order of the recorded temporal data,

the storage means comprise a rewritable memory making it possible to modify the recorded data;

locating means are provided so as to allow the locating of the label when the means of communication transmit a warning message to the external device;

the locating means are chosen from a transmitter of visible light signals, a transmitter of audible acoustic signals and a buzzer;

the means of communication are also able to receive coded search messages from the external device and when the coded search messages contain the label's identifying code, the central unit is able to activate the means of communication so as to transmit a return message to the external device, the return message containing at least the identifying code by virtue of which the label can be detected and identified;

the central unit is also able to actuate locating means when the coded search messages contain the label's identifying code;

fixing means are provided so as to fix said label to the article associated therewith;

the label is electrically powered by a cell; and

the means of communication are adapted for transmitting and receiving radio-frequency messages.

The subject of the invention is also a system for aiding the archiving of a plurality of articles, each article being provided with an electronic label such as defined above, each label comprising a unique identifying code and the system also comprising an external device comprising means of communication for at least receiving the warning message from each label, said external device being able to analyze the warning messages sent by said labels so as to identify each label by means of its identifying code

According to another advantageous characteristic of the system, the means of communication of the external device are also able to transmit a search message comprising the identifying code of at least one label, and the labels receiving the search message are able to compare it with their identifying code so as to transmit, when the comparison is positive, a coded return message to the external device, said external device comprising checking means making it possible to trigger an alarm when at least one label for which the search message was intended has not transmitted a coded return message.

According to yet another advantageous characteristic of the system, the central unit of the labels is able to actuate locating means internal to the labels when the comparison of the coded search message with their identifying code is positive.

Other characteristics and advantages of the invention will become apparent in the course of the following description of two of its embodiments, given by way of non-limiting examples, in conjunction with the attached drawings.

In the drawings:

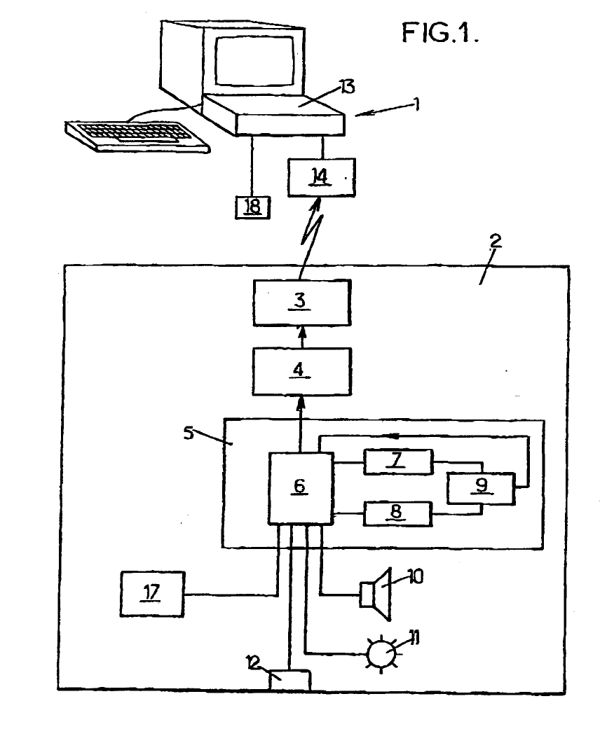

FIG. 1 is a diagrammatic view of a system for siding archiving using a label in accordance with a first embodiment of the invention, the label being represented by a partial block diagram,

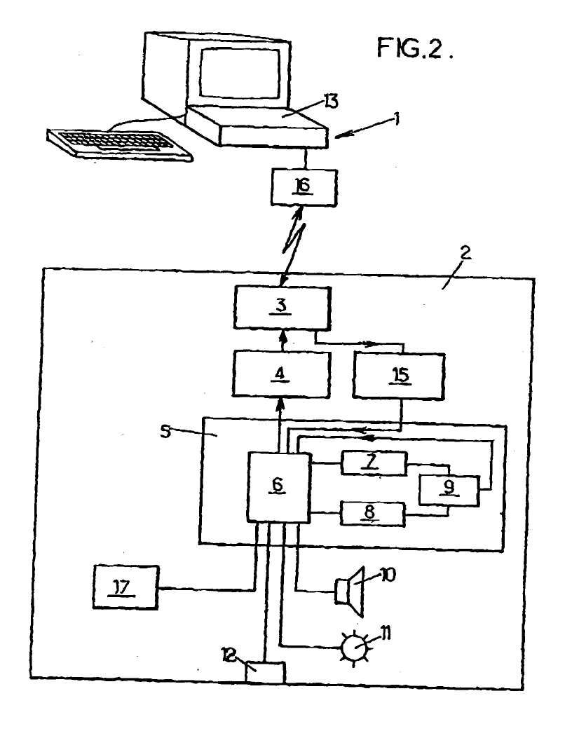

FIG. 2 is a diagrammatic view of a system for aiding archiving using a label in accordance with a second embodiment of the invention, the label being represented by a partial block diagram,

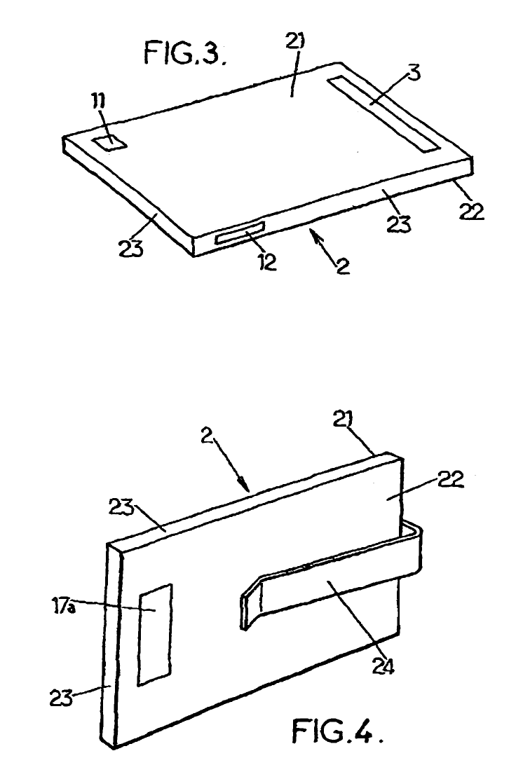

FIGS. 3 and 4 are perspective views of a label in accordance with the invention, and

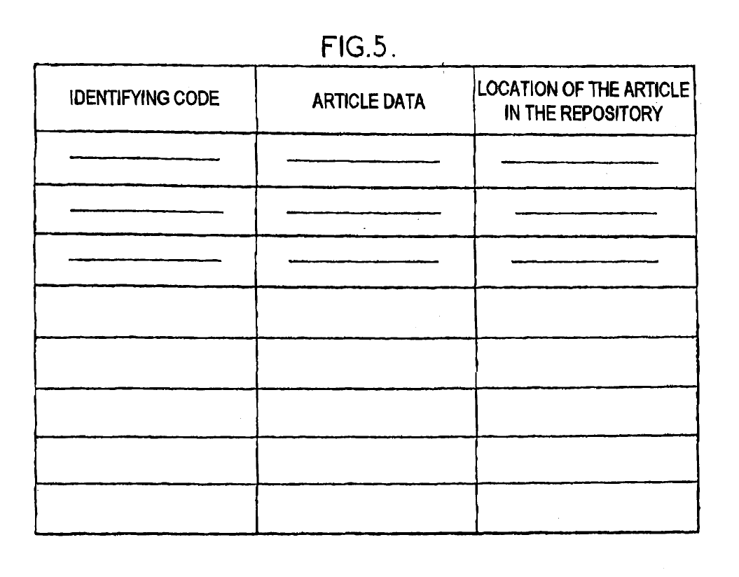

FIG. 5 represents an array for aiding archiving used in the system in accordance with the invention.

In the various figures, the same references denote identical or similar elements.

FIG. 1 diagrammatically illustrates the use of a system in accordance with the invention which affords users aid with the archiving of articles such as pharmaceutical products, products offered for sale, documents or pouches, etc., which have to be monitored, checked and/or located at precise instants throughout the duration of their storage.

The system for aiding the archiving of a plurality of articles (which are not represented) comprises chiefly an external device 1 which will be described in greater detail later in the description, and a plurality of electronic labels 2 (one of which is represented in FIG. 1) which are each intended to be affixed to an article stored for example in shelves.

Each electronic label 2 belonging to the archiving system chiefly comprises:

an antenna 3 for transmitting coded radio messages,

a transmission circuit 4 which includes, in a manner known per se, a modulator and an amplifier for respectively modulating and amplifying the coded radio messages sent to the antenna 3,

a central unit 5 which controls the transmission circuit 4, the central unit 5 comprising at least one microprocessor or microcontroller 6 adapted for processing the messages transmitted, this microprocessor 6 being linked in particular to a time clock 7 and to at least one memory 8 which form part of the central unit 5, the memory 8 comprising an identifying code which is unique for each of the labels (or possibly for a batch of labels assigned to identical or similar articles),

means of comparison 9 which are linked to the clock 7 and to the memory 8 and which are capable of sending control signals to the microprocessor 6 as a function of a predetermined comparison which will be explained in greater detail hereinbelow,

a cell 17 which constitutes the standalone power supply for each label, and

a port 12 for connection with the exterior, in particular a port for connection by physical contact, which makes it possible through the intermediary of the microprocessor 6 to record data in the memory 8 of the central unit 5.

Thus, when an article is to be stocked or stored in an appropriate place, the user associates a label with the article in question and records in the memory 8 of the label temporal data corresponding to a precise instant in relation to the storage of said article.

These temporal data may take the form of a date of expiry in the case where the article to be stored consists, for example, of a pharmaceutical product.

However, the temporal data may also take the form of a date and a precise time in the case where the article is a dossier which must for example be monitored or removed from the archives for whatever reason on the date and at the time recorded in the memory 8.

The recording of the temporal data in the memory 8 is achieved for example by connecting the port 12 of the label with the external device 1. This external device comprises an electronic processing unit 13 which here consists of a microcomputer or the like.

Of course, the recording of the temporal data in the memory 8 can also be achieved by way of any other means of recording independent of the microcomputer 13, for example through the intermediary of a handheld device which connects up directly to the connection port 12 of the label.

The microcomputer 13 is provided with a database which comprises the internal identifying code of each electronic label so as to be able to identify them subsequently.

During the storage of the article bearing the label 2, the time clock 7 of the label, which has to be updated before fixing to the article in question, then supplies temporal information to the means of comparison 9 which are also linked to the memory 8.

These means of comparison 9 compare the temporal information supplied by the clock 7 with the temporal data recorded in the memory 8 and when this comparison is positive, that is to say when the temporal information is identical or corresponds to the recorded temporal data, the means of comparison transmit a signal to the microprocessor 6. Of course, it is understood that the means of comparison 9 may be internal to the microprocessor 6 which can itself make the comparison of the recorded temporal data with the information supplied for the clock 7.

In response to the signal transmitted by the means of comparison, the microprocessor 6 then activates the transmission circuit 4 so as to transmit a warning signal to the external device 1 which for this purpose comprises an antenna 14 coupled to the microcomputer 13.

The warning message transmitted by the label and which comprises at least its identifying code is analyzed by the microcomputer 13 which, with the help of the database comprising the set of identifying codes for the labels, automatically identifies the transmitting label.

The microcomputer 13 then displays on a display screen, the identifying code of the transmitting label so as to inform the user that the article associated with the label has to be checked and/or possibly withdrawn from the repository.

In order to accurately locate the transmitting label when the latter sends the warning message to the external device in order to alert the user, each label is provided with locating means. The locating means comprise a transmitter of visible light signals 11 or a transmitter of audible acoustic signals 10 or else a buzzer which is linked directly to the microprocessor 6.

Thus, when the means of comparison 9 of each label transmit a positive comparison signal to the microprocessor 6, the latter then activates the transmission means 4 and the locating means 10 or 11 which will allow the user, on the one hand, to ascertain through the intermediary of the external device 1, that a label has triggered and, on the other hand, to thereafter locate the transmitting label through the intermediary of its locating means.

Advantageously, the microcomputer 13 can be provided with a database management system which comprises an allocation table containing at least in a first field the internal identifying code of each label and in a second field data relating to the article to which the label is affixed.

These data relating to the article are, for example:

the type of article,

the name of the manufacturer of the article,

the serial number of the article,

the country of manufacture of the article,

the task to be performed in relation to the article when the label triggers.

Thus, when the microcomputer identifies the label through its identifying code, the allocation table makes it possible to display on the display screen the label's identifying code and correspondingly the data relating to the article which has for example to be removed from the repository.

Stated otherwise, each article is assigned, by way of the data relating to it, the identifying code of the label associated therewith.

However, provision may also be made to directly record the data relating to the article in the memory 8 of the label, in the case where the microcomputer is replaced by a handheld device devoid of any allocation table or of databases relating to the various identifying codes. In this case, the warning message transmitted by the label will advantageously comprise the identifying code and the data relating to the article in question, so that the handheld device displays on its display screen the identifying code of the transmitting label and the data relating to the article to which the transmitting label is fixed.

This handheld device which can be carried directly by the user thus enables the latter to monitor in real time the state of the repository and hence the auto-triggering of the various labels, without however being compelled to check the shelves periodically in order to check whether a label may have triggered.

Advantageously, the transmission circuit 4 and the antenna 3 of each of the labels will be adapted to transmit messages with a free-field range of 50 to 800 m. Thus, the external device can be disposed externally to the repositories.

According to another alternative embodiment of the invention, the microcomputer 13 of the external device can also comprise an allocation table which in a third field (FIG. 5) comprises data relating to the exact location of the article in the stock.

Thus, before any operation of storing an article, the user searches, through the intermediary of the database relating to the various identifying codes of the set of labels, for an identifying code of an available label, that is to say of a label which has not yet been assigned to any of the articles and assigns this identifying code in the first field of the allocation table. Thereafter, the user enters the data relating to the article in question into the microcomputer by any means of acquisition such as a keyboard, so that the microcomputer assigns these data (task to be performed, serial number of the article and/or type of article, etc.) in the second field in correspondence with the label's identifying code. And finally, in a third field of the allocation table the user writes the data relating to the exact location in which the article in question will be stored.

The user thereafter records the temporal data in relation to the article in the memory 8 of the label by means of an interface 18 linked to the microcomputer 13, this interface 18 being engaged into the connection port 12 of the label. The label is thereafter fixed to the article which is ready to be stored at its location.

Thus, when the label triggers, the microcomputer 13 analyzes the warning message transmitted by the label, this warning message comprising solely the identifying code, and the microcomputer then automatically displays the data relating to the article as well as its exact location in the repository, thereby enabling the user to locate the article. It is understood that with this alternative embodiment, the label may be devoid of internal locating means.

As is more visible in FIGS. 3 and 4, each label 2 takes the form of a rectangular parallelepipedal panel having front 21 and rear 22 main faces and four sides 23. The panel encloses the encoded electronic circuit, the standalone power supply 17, the antenna 3 and possibly the locating means which may comprise a light-emitting diode 11. The standalone power supply 17 may be implemented in the form of a flat cell which is received in an internal housing 17a made on the rear face 22 of the label. The rear face 22 of the label also comprises fixing means 24 which can take the form of a clip allowing the fixing of the label to the article. According to the type of article to be stored or archived, the clip 24 may be replaced by any other means, for example a self-adhesive material.

The connection port 12 of the label is preferably disposed on one of the sides 23 of the panel, while the light-emitting diode is disposed on the front face 21 of the panel.

The panel can for example have a length of around 45 mm for a width of 30 mm and a thickness of 5 mm.

According to a second embodiment of the invention, represented in FIG. 2, the labels belonging to the system for aiding archiving also comprise a reception circuit 15 linked to the antenna 3 and to the microprocessor 6 of the central unit 5.

This reception circuit 15 is adapted for receiving and modulating radio-frequency signals received by the antenna 3 from the external device 1.

For this purpose, the external device 1 comprises a box 16 serving to transmit messages to labels and also to receive messages transmitted by the labels. This box 16 is coupled to an electronic processing unit 13 which here consists of a microcomputer.

The computer 13 is provided with a database management system which is able to carry out virtual search operations on the basis of an allocation table. This allocation table can contain in a first field the identifying code of the labels and in supplementary fields the data relating to the article to which the label is affixed.

Thus, when an article has been filed away or stored in a shelf, the user can perform a virtual search for the article which he wishes to retrieve by means of the database management system of the computer 13. This virtual search can be performed according to criteria connected with the article-related data recorded in fields of the allocation table.

When the article or articles being searched for have thus been selected through specific criteria (tasks to be performed on the article, type of article, date of manufacture, destination of the article, etc.) the computer 13 then searches through the allocation table for the identifying code cf the label corresponding to the selected article. The identifying code or codes are then sent to the box 16 which then transmits a coded search message containing the identifying codes of the labels associated with the selected articles.

The reception circuit 15 of each label, receiving this coded search message, then sends it to the microprocessor 15 which compares the identifying code or codes contained in this search message with the identifying code contained in the memory 8 of the label. For the label whose code has been selected, and for this label only, the identity between the code of the search message and the internal code of the label is noted, so that the microprocessor activates the transmission circuit 4 so as to transmit a return message to the external device 1. This return message sent by the selected label comprises the label's identifying code so that the computer 13 checks that the selected label, and therefore consequently the article associated therewith, are indeed present in the repository.

When the identity between the code of the search message and the internal code of the label is noted, the microprocessor 6 can also activate said label's locating means so as to enable the user to more easily retrieve the selected article.

When the label selected by the search message does not send any coded return message to the computer 13 within a predetermined timespan, the computer 13 is then able to trigger an alarm so as to alert the user that the article associated with the label is no longer present in the repository.

Advantageously, each electronic label according to the first embodiment or the second embodiment can also comprise an on/off button which makes it possible in articular to disable the labels when the latter are not assigned to an article. In this case, the time clock of the electronic labels is reupdated when the label is powered up for example with the help of the connection port 12 linked to the microprocessor 6.

Moreover, the connection port 12 of the label can be dispensed with and in this case the recording of the various data in the memory of the label is achieved through remote recording means. For example, the label can in particular comprise an antenna coil, a central unit and an electrically erasable and programmable memory which is connected to the central unit by means of a bus. The central unit caters for the operations of demodulating a voltage induced in the coil for the reception of data coming from the external device and the operations of modulating the load of the antenna coil for the transmission of data to the external device. Thus, data can be read from or written to the memory of the label by way of the central unit which caters for the same controls as the central unit described previously.

1. An electronic label intended to be affixed to an article, the label comprising a central unit (5) which comprises storage means (8),
characterized in that it furthermore comprises means of remote communication (4, 15) for at least transmitting and/or receiving messages to an external device (1), said means of communication being linked to the central unit (5),
in that the storage means (8) comprise an identifying code for the label and temporal data corresponding to a precise instant in relation to the storage of said article,
in that the central unit also comprises a clock (7) and means of comparison (9) for comparing the temporal data recorded in the storage means (8) with temporal information supplied by the clock (7),
and in that the central unit is able to activate the means of communication (4, 15) so as to transmit a warning message to the external device (1) when the temporal information supplied by the clock (7) is in a predetermined relation with the recorded temporal data, the warning message comprising at least the identifying code by virtue of which the label can be identified.

2. The label as claimed in claim 1, in which the storage means (8) also comprise supplementary data relating to the article to which the label is intended to be affixed or into which it can be inserted, and these supplementary data are also sent to the external device (1) by the warning message when the temporal information supplied by the clock (7) is in a predetermined relation with the recorded temporal data.

3. The label as claimed in one or the other of claims 1 and 2, in which the storage means (8) comprise a rewritable memory making it possible to modify the recorded data.

4. The label as claimed in any one of the preceding claims, in which locating means (10; 11) are provided so as to allow the locating of the label when the means of communication (4) transmit a warning message to the external device (1).

5. The label as claimed in claim 4, in which the locating means are chosen from a transmitter of visible light signals (11), a transmitter of audible acoustic signals (10) and a buzzer.

6. The label as claimed in any one of the preceding claims, in which the means of communication (15) are also able to receive coded search messages from the external device (1) and when the coded search messages contain the label's identifying code, the central unit (5) is able to activate the means of communication so as to transmit a return message to the external device (1), the return message containing at least the identifying code by virtue of which the label can be detected and identified.

7. The label as claimed in claim 6, in which the central unit (5) is also able to actuate locating means (10; 11) when the coded search messages contain the label's identifying code.

8. The label as claimed in any one of the preceding claims, in which fixing means (24) are provided so as to fix said label to the article associated therewith.

9. The label as claimed in any one of the preceding claims, electrically powered by a cell (17).

10. The label as claimed in any one of the preceding claims, in which the means of communication are adapted for transmitting and receiving radio-frequency messages.

11. A system for aiding the archiving of a plurality of articles, each article being provided with an electronic label (2) according to one or other of the preceding claims, each label comprising a unique identifying code and the system also comprising an external device (1) comprising means of communication (14) for at least receiving the warning message from each label, said external device (1) being able to analyze the warning messages sent by said labels so as to identify each label by means of its identifying code.

12. The system as claimed in claim 11, in which the means of communication (14) of the external device are also able to transmit a search message comprising the identifying code of at least one label, and the labels receiving the search message are able to compare it with their identifying code so as to transmit, when the comparison is positive, a coded return message to the external device, said external device comprising checking means making it possible to trigger an alarm when at least one label for which the search message was intended has not transmitted a coded return message.

13. The system as claimed in claim 12, in which the central unit (5) of the labels is able to actuate locating means (10; 11) internal to the labels when the comparison of the coded search message with their identifying code is positive.
